(19) United States
(12) Patent Application Publication
(10) Pub. No.: US 2017/0314495 A1
(43) Pub. Date: Nov. 2, 2017

(54) CONTROL DEVICE FOR INTERNAL COMBUSTION ENGINE

(71) Applicant: DENSO CORPORATION, Kariya-city, Aichi-pref. (JP)

(72) Inventor: Tomohiro KANAYA, Kariya-city, Aichi-pref. (JP)

(21) Appl. No.: 15/523,427

(22) PCT Filed: Oct. 28, 2015
(86) PCT No.: PCT/JP2015/005422

§ 371 Date: May 1, 2017

(30) Foreign Application Priority Data
Nov. 4, 2014 (JP) 2014-224764

(51) Int. Cl. F02D 41/26; F02D 41/06; F01L 1/344; F02N 11/08; F02D 13/02

(52) U.S. Cl. CPC F02D 41/26; F02N 11/08; F02D 13/02; F02D 41/062; F01L 1/3442; F01L 2001/34459; F02D 2200/0414; F02D 2200/503; F02D 2200/023

(57) ABSTRACT

At a time of a startup in a non-lock state (at the time of a next startup in a case where an internal combustion engine is stopped in a non-lock state in which a VCT phase is not locked in an intermediate lock phase), it is determined whether or not the engine can be started up by most delayed startup processing. In a case where it is determined that the engine can be started up by the most delayed startup processing, the most delayed startup processing is performed. In this most delayed startup processing, the engine is cranked in a high rotation range not less than a specified rotation speed and a fuel injection and an ignition are started in a state in which the VCT phase is controlled to a vicinity of the most delayed phase (most delayed phase or within a specified range from the most delayed phase) to thereby start up the engine. In this way, at the time of the startup in the non-lock state, the engine can be quickly started up without locking the VCT phase.

### CROSS REFERENCE TO RELATED APPLICATIONS

This application is based on Japanese Patent Application No. 2014-224764 filed on Nov. 4, 2014, the disclosure of which is incorporated herein by reference.

### TECHNICAL FIELD

The present disclosure is an invention related to a control device for an internal combustion engine provided with a variable valve timing device including an intermediate lock mechanism which locks a rotation phase of a camshaft to a crankshaft of the internal combustion engine (VCT phase) in an intermediate phase.

### BACKGROUND ART

An internal combustion engine mounted in a vehicle is mounted with a variable valve timing device that varies a rotation phase of a camshaft to a crankshaft of the internal combustion engine (VCT phase) to thereby vary a valve timing (opening/closing timing) of an intake valve and an exhaust valve for the purpose of increasing an output, decreasing a fuel consumption, reducing an emission, and the like.

In a variable valve timing device of a hydraulic drive type, there is proposed a device provided with an intermediate lock mechanism that locks a VCT phase in an intermediate phase located within an adjustable range of the VCT phase (for example, a VCT phase suitable for a startup). This intermediate lock mechanism is constructed, for example, in such a way that a lock pin is protruded and fitted in a fitting hole to thereby fix the VCT phase in an intermediate lock phase. In a system provided with the intermediate lock mechanism constructed in this way, the VCT phase is locked in the intermediate lock phase before the internal combustion engine is stopped and at the time of a next startup, the internal combustion engine is started up in a state in which the VCT phase is locked in the intermediate phase, whereby startability can be improved.

However, when a situation in which preference needs to be given to a part protection, a user's operation, or the like is caused and hence a quick stop request is made when the internal combustion engine is being operated, there is a case where the internal combustion engine is stopped in a non-lock state in which the VCT phase is not locked in the intermediate phase. As a countermeasure for a case where the internal combustion engine is stopped in the non-lock state is proposed, for example, a variable valve timing device disclosed in a patent literature 1 (JP 2012-36735 A). This variable valve timing device vibrates and varies the VCT phase to the intermediate phase by the use of a rotational variation (rotational pulsation) caused by a variation in a cam torque while the internal combustion engine is being cranked and locks the VCT phase in the intermediate lock phase and starts up the internal combustion engine.

Further, a lock mode for protruding a lock pin of the intermediate lock mechanism is used in some cases also for starting/stopping the internal combustion engine when a conventional internal combustion engine is being operated or is in a lock state. In the lock mode, an oil supply to an advance chamber and a delay chamber of the variable valve timing device is interrupted or inhibited but the oil is not positively discharged from the advance chamber and the delay chamber. This is because of avoiding a problem such that at the time of a phase control after the lock mode, the advance chamber and the delay chamber are not yet charged with the oil and hence a phase control becomes difficult. Hence, the oil in the advance chamber and the delay chamber is held as much as possible.

However, in a system in which at the time of a startup in a non-lock state (at the time of a next startup in a case where an internal combustion engine is stopped in the non-lock state), a VCT phase is varied to and locked in an intermediate lock phase by the use of a rotational variation caused by a variation in a cam torque when the internal combustion engine is being cranked, the following state is likely to be caused.

When the oil (in particular, oil of high viscosity) remains in the advance chamber and the delay chamber in the lock mode at the time of the startup in the non-lock state, the VCT phase cannot be vibrated in a sufficient amplitude only by the rotational variation caused by the variation in the cam torque, which hence is likely to make it impossible to vary the VCT phase to the intermediate phase and to lock the VCT phase. For this reason, a period of time which elapses until the startup is completed is likely to be abnormally elongated. In addition, it is difficult to measure or estimate an amount of oil remaining in the advance chamber and the delay chamber, and in a case where the VCT phase is not moved at the time of the startup in the non-lock state, it cannot be determined whether this is caused by the lock pin being fixed or by the oil of high viscosity remaining in the advance chamber and the delay chamber, which hence a great delay is likely to be caused for taking measures against this problem.

Further, in recent years, for the purpose of improving a fuel consumption, the friction of the internal combustion engine tends to be decreased and also an internal combustion engine having a small cam torque has been examined. In this internal combustion engine like this, the cam torque is small and hence a rotational variation caused by a variation in the cam torque cannot be sufficiently obtained and hence the VCT phase cannot be vibrated in a sufficient amplitude, so that the VCT phase is likely not to be varied to and locked in the intermediate phase. For this reason, a period of time which elapses until the startup is completed is likely to be abnormally elongated.

Still further, in a system to crank an internal combustion engine by a higher output motor than a typical starter in the prior art, like a hybrid vehicle provided with an internal combustion engine and a motor as a power source of the vehicle and a vehicle provided with a motor to assist an internal combustion engine, the internal combustion engine can be cranked at a higher rotation speed than a typical cranking rotation speed in prior art. The system to crank the internal combustion engine at a high rotation in this way is hard to be affected by a variation in the cam torque and cannot sufficiently obtain a rotational variation caused by a variation in the cam torque, so that the VCT phase is likely not to be vibrated in a sufficient amplitude and hence the VCT phase is likely not to be varied to and locked in the intermediate phase. For this reason, a period of time which elapses until the startup is completed is likely to be abnormally elongated.

Still further, there is also proposed a variable valve timing device which is provided with a ratchet mechanism to inhibit the VCT phase from returning in a reverse direction (direction separate from the intermediate phase) when the VCT phase is varied to the intermediate lock phase by the use of a rotational variation caused by the variation in the cam torque. However, in this case, a construction is complicated and hence a lock pin is also likely to be fixed.

### PRIOR ART LITERATURES

### Patent Literature

Patent Literature 1: JP 2012-36735 A

### SUMMARY OF INVENTION

An objective of the present disclosure is to provide a control device for internal combustion engine that can quickly start up an internal combustion engine without locking a VCT phase at the time of a startup in a non-lock state (at the time of the next startup in a case where the internal combustion engine is stopped in a non-lock state).

According to one aspect of the present disclosure, a control device for internal combustion engine includes: a variable valve timing device of a hydraulic drive type which varies a rotation phase of a camshaft to a crankshaft of an internal combustion engine (hereinafter referred to as “VCT phase”) to thereby vary a valve timing; an intermediate lock mechanism which locks the VCT phase in an intermediate lock phase located within an adjustable range of the VCT phase; and a control part which locks the VCT phase in the intermediate lock phase before the internal combustion engine is stopped and which starts up the internal combustion engine at the time of a next startup in a state in which the VCT phase is locked in the intermediate lock phase. In a case where the internal combustion engine is stopped in a non-lock state in which the VCT phase is not locked in the intermediate lock phase, at the time of the next startup, the control part performs most delayed startup processing for controlling the VCT phase to a most delayed phase or to within a specified range from the most delayed phase (hereinafter, these will be collectively referred to as “a vicinity of the most delayed phase”) and starting up the internal combustion engine.

In recent years, there has been widely used a system that can crank an internal combustion engine at a higher rotation speed than a typical cranking rotation speed in the prior art. In this system, a range of a VCT phase in which the internal combustion engine can be started up is expanded and the internal combustion engine can be started up even when the VCT phase is in a most delayed phase.

By paying attention to this point, in the present disclosure, in a case where the internal combustion engine is stopped in the non-lock state in which the VCT phase is not locked in the intermediate lock phase, at the time of the next startup, the control part performs the most delayed startup processing for controlling the VCT phase to the vicinity of the most delayed phase (the most delayed phase or within a specified range from the most delayed phase) and starting up the internal combustion engine.

According to this, at the time of a startup in the non-lock state (at the time of the next startup in a case where the internal combustion engine is stopped in the non-lock state), the internal combustion engine can be started up in a state in which the VCT phase is displaced to the most delayed phase or is brought close to the most delayed phase. In this way, at the time of the startup in the non-lock state, the internal combustion engine can be quickly started up without locking the VCT phase. In this case, at the time of the startup in the non-lock state, the VCT phase does not need to be locked, which hence can prevent a phenomenon that can be caused in a case where the VCT phase is locked at the time of startup in the non-lock state

### BRIEF DESCRIPTION OF THE DRAWINGS

The above and other objects, features, and advantages of the present disclosure will become more apparent from the following detailed description made with reference to the accompanying drawings.

FIG. 1 is a figure to show a general construction of an engine control system in a first embodiment of the present disclosure.

FIG. 2 is a longitudinal sectional side view to illustrate a construction of a variable valve timing device and a hydraulic control circuit.

FIG. 3 is a longitudinal sectional front view of the variable valve timing device.

FIG. 4 is a section view of an intermediate lock mechanism.

FIG. 5 is a graph to show a control mode of a hydraulic control valve.

FIG. 6 is a graph to show a cranking rotation speed.

FIG. 7 is a time chart to show an example to perform most delayed startup processing.

FIG. 8 is a time chart to show an example to perform most advanced startup processing.

FIG. 9 is a time chart to show an example to perform intermediate startup processing.

FIG. 10 is a flow chart to show a flow of processing of a main control routine.

FIG. 11 is a flow chart to show a flow of processing of a normal startup processing routine.

FIG. 12 is a flow chart to show a flow of processing of a most delayed startup permission determination routine.

FIG. 13 is a flow chart to show a flow of processing of a most delayed startup processing routine.

FIG. 14 is a flow chart to show a flow of processing of a most advanced startup processing routine.

FIG. 15 is a flow chart to show a flow of processing of an intermediate startup processing routine.

FIG. 16 is a flow chart to show a flow of processing of a most delayed startup processing routine of a second embodiment.

### EMBODIMENT FOR CARRYING OUT INVENTION

Hereinafter, several embodiments in which a mode for carrying out the present disclosure is embodied will be described.

### First Embodiment

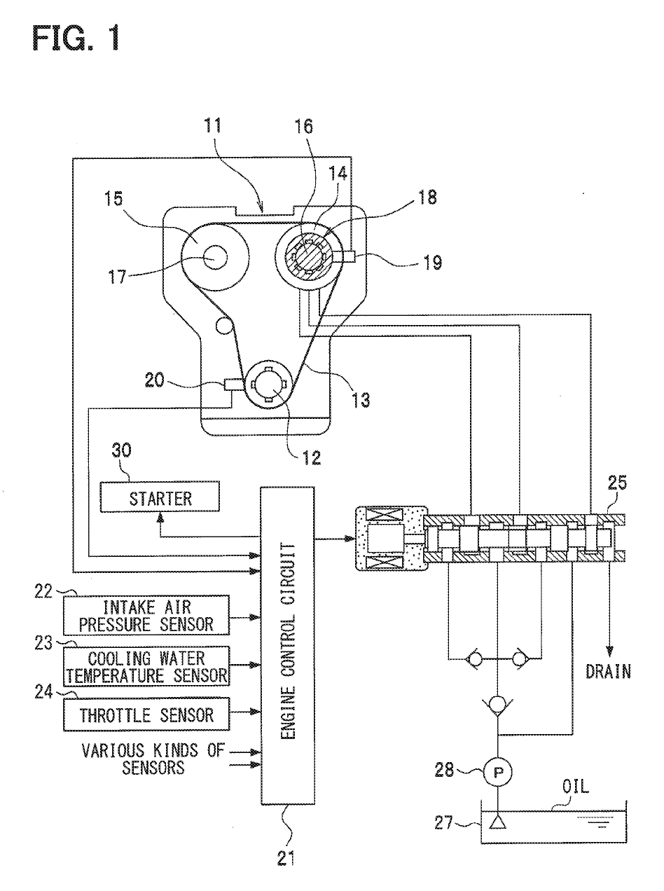

A first embodiment of the present disclosure will be described on the basis of FIG. 1 to FIG. 15.

As shown in FIG. 1, in an engine 11 of an internal combustion engine, power from a crankshaft 12 is transmitted to an intake-side camshaft 16 and an exhaust-side camshaft 17 by a timing chain 13 (or timing belt) via respective sprockets 14, 15. The intake-side camshaft 16 is provided with a variable valve timing device 18 (VCT) of a hydraulic drive type. A rotation phase of the intake-side camshaft 16 to the crankshaft 12 (hereinafter referred to as “VCT phase”) is varied by the variable valve timing device 18, whereby a valve timing (opening/closing timing) of an intake valve (not shown in the drawing), which is opened or closed by the intake-side camshaft 16, is varied.

Further, on an outer peripheral side of the intake-side camshaft 16, a cam angle sensor 19 is arranged which outputs a pulse of a cam angle signal at a specified cam angle so as to distinguish a cylinder. On the other hand, on an outer peripheral side of the crankshaft 12, a crank angle sensor 20 is arranged which outputs a pulse of a crank angle signal at intervals of a specified crank angle. Output signals of the cam angle sensor 19 and the crank angle sensor 20 are inputted to an engine control circuit 21. The engine control circuit 21 calculates a real valve timing of an intake valve (real VCT phase) on the basis of a phase difference in an output signal pulse between the cam angle sensor 19 and the crank angle sensor 20 and calculates an engine rotation speed on the basis of a frequency of an output pulse (pulse interval) of the crank angle sensor 20. In addition, output signals of various kinds of sensors to sense an engine operating state (an intake pressure sensor 22, a cooling water temperature sensor 23, a throttle sensor 24, and the like) are inputted to the engine control circuit 21.

The engine control circuit 21 performs a fuel injection control and an ignition control according to the engine operating state sensed by the various kinds of sensors and controls a hydraulic pressure to drive the variable valve timing device 18 in such a way that a real valve timing of the intake valve (real VCT phase) corresponds with a target valve timing (target VCT phase) set according to the engine operating state.

Further, there is provided a starter 30 to rotate (crank) the crankshaft 12 at the time of starting up the engine 11. When the engine 11 is cranked by the starter 30, the engine 11 can be cranked in a high rotation range not less than a specified rotation speed. Here, the high rotation range not less than the specified rotation speed means, for example, a high rotation range not less than a rotation speed which can start up the engine 11 by most delayed startup processing, which will be described later, in a normal temperature state, and a rotation speed higher than a conventional cranking rotation speed (for example, 130 rpm to 300 rpm). In this regard, the normal temperature state is assumed to be a temperature higher than an extremely low temperature (for example, not more than −30° C.).

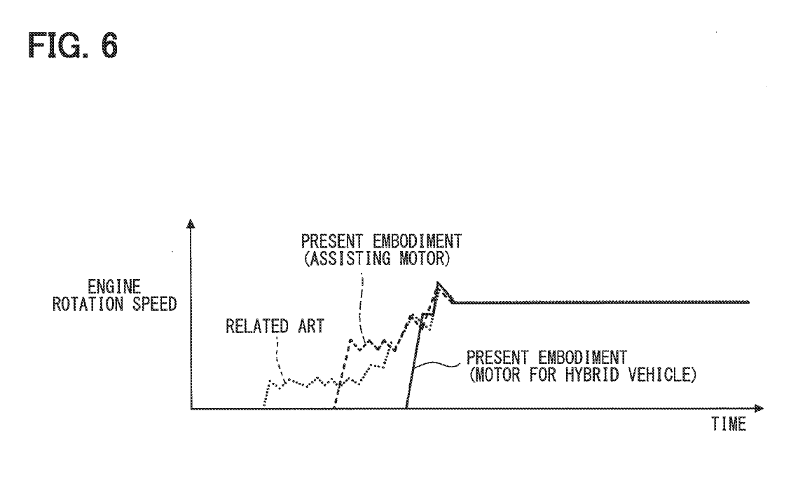

In a case of a hybrid vehicle mounted with the engine 11 and a motor (for example, MG (motor generator)) as a power source of the vehicle, when the engine 11 is cranked by using this motor dedicated for the hybrid vehicle as the starter 30, the engine 11 can be cranked in the high rotation range (for example, 650 rpm to 900 rpm) not less than the specified rotation speed (see FIG. 6).

Further, in a case of a vehicle mounted with a motor to assist the engine 11 (for example, ISG (integrated starter generator)), when the engine 11 is cranked by using the assisting motor as the starter 30, the engine 11 can be cranked in the high rotation range (for example, 250 rpm to 450 rpm) not less than the specified rotation speed (see FIG. 6).

Still further, as the starter 30 may be used a high output starter which can crank the engine 11 in the high rotation range (for example, 250 rpm to 450 rpm) not less than the specified rotation speed (starter of a higher output than a typical starter in the prior art).

Still further, by reducing the friction of the engine 11, the engine 11 can be cranked in the high rotation range (for example, 250 rpm to 450 rpm) not less than the specified rotation speed even by the typical starter in the prior art (hereinafter referred to as “normal starter”). In this case, as the starter 30 may be used the normal starter but may be used any one of the motor dedicated for the hybrid vehicle, the assisting motor, and the high output starter.

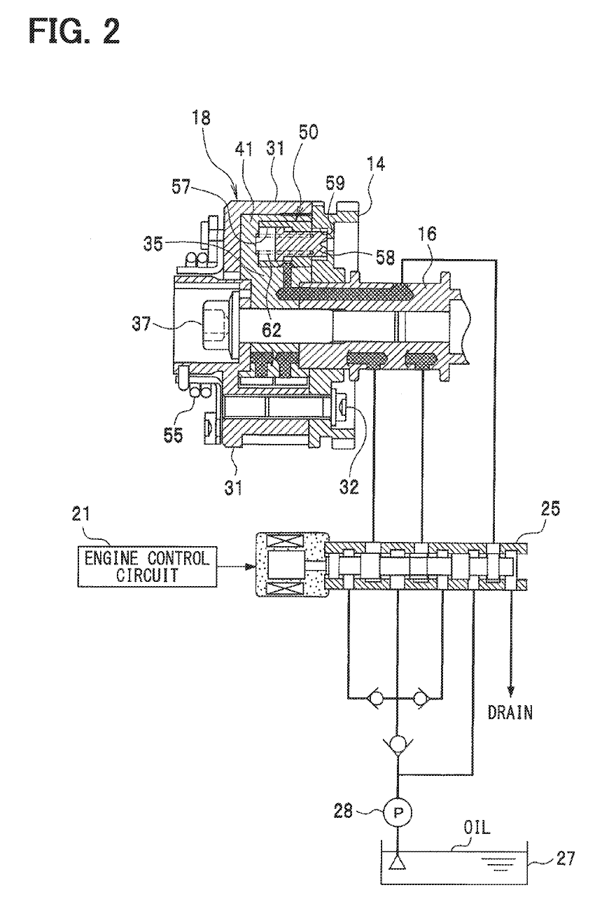

Next, a construction of the variable valve timing device 18 will be described on the basis of FIG. 2 to FIG. 4.

A housing 31 of the variable valve timing device 18 is fixed to the sprocket 14 rotatably supported on an outer periphery of the intake-side camshaft 16 by fastening a bolt 32. In this way, a rotation of the crankshaft 12 is transmitted to the sprocket 14 and the housing 31 via the timing chain 13, whereby the sprocket 14 and the housing 31 are rotated synchronously with the crankshaft 12. On the other hand, a rotor 35 is fixed to one end portion of the intake-side camshaft 16 by fastening a bolt 37. This rotor 35 is received in the housing 31 in such a way as to be relatively freely pivoted.

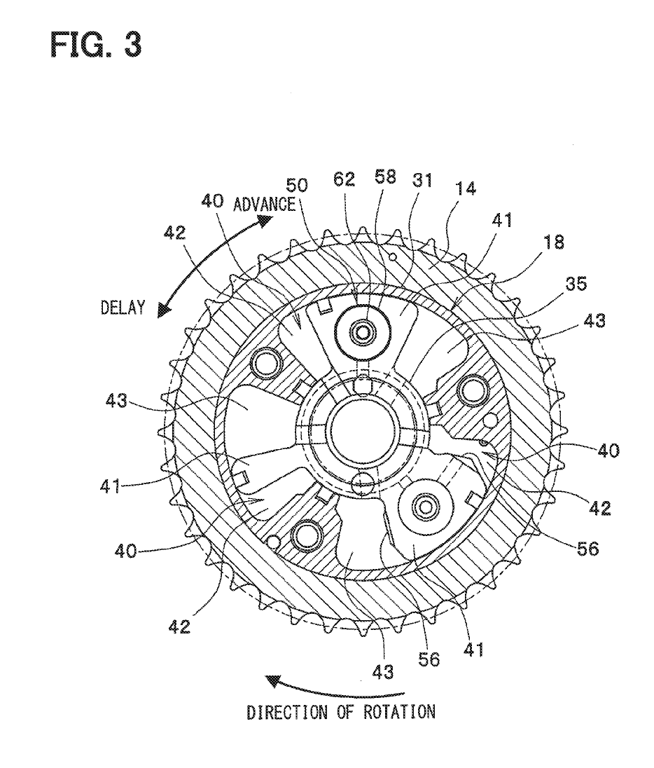

As shown in FIG. 3, a plurality of vane receiving chambers 40 are formed in the housing 31, and each of the vane receiving chamber 40 is partitioned into an advance chamber 42 and a delay chamber 43 by a vane 41 formed on an outer peripheral portion of the rotor 35. Stopper parts 56 to regulate a relative pivotal range of the rotor 35 (vane 41) to the housing 31 are formed on both sides of at least one vane 41, and a most delayed phase and a most advanced phase of an adjustable range of the real VCT phase (camshaft phase) are regulated by these stopper parts 56.

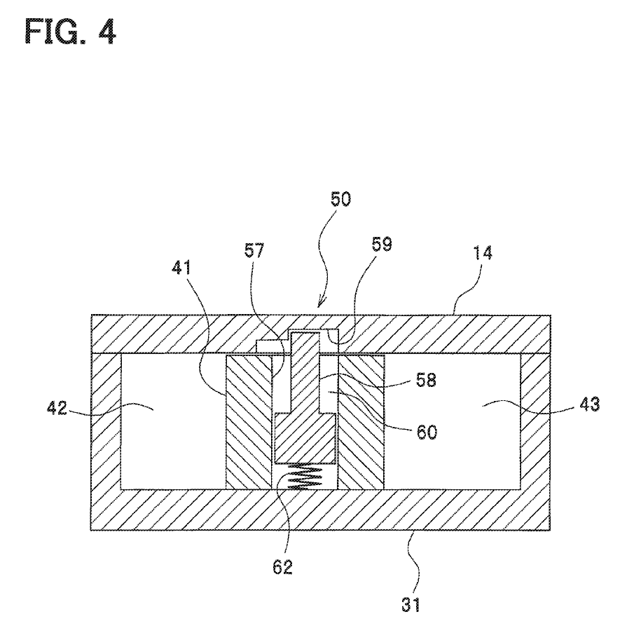

As shown in FIG. 3 and FIG. 4, the variable valve timing device 18 is provided with an intermediate lock mechanism 50 that locks a VCT phase at an intermediate phase located between the most delayed phase and the most advanced phase (for example, nearly intermediate phase) of the adjustable range of the VCT phase. In the intermediate lock mechanism 50, a lock pin receiving hole 57 is formed in any one (or a plurality) of the vanes 41, and a lock pin 58 for locking a relative pivot between the housing 31 and the rotor 35 (vane 41) is received in the lock pin receiving hole 57 in such a way as to be able to protrude. The lock pin 58 is protruded to a sprocket 14 side and is fitted in a lock hole 59 of the sprocket 14, whereby the VCT phase is locked in an intermediate lock phase located at a nearly intermediate position of the adjustable range. The intermediate lock phase is set to a phase suitable for starting up the engine 11. In this regard, a construction in which the lock hole 59 is formed in the housing 31 may be employed. The lock pin 58 is biased in a lock direction (protruding direction) by a spring 62. Further, a lock releasing hydraulic chamber 60 for controlling a hydraulic pressure to drive the lock pin 58 in a lock releasing direction (direction opposite to the lock direction), is formed between an outer peripheral portion of the lock pin 58 and the lock pin receiving hole 57.

Further, as shown in FIG. 2, the housing 31 is provided with a spring 55 of a torsion coil spring or the like to bias the rotor 35 in an advance direction. In the variable valve timing device 18 of the intake valve, a torque of the intake-side camshaft 16 is operated in a direction to delay the VCT phase, so that the spring 55 results in biasing the VCT phase in the advance direction which is a direction opposite to a torque direction of the intake-side camshaft 16. A range in which a biasing force of the spring 55 is operated is set in a range from the most delayed phase to a nearly intermediate lock phase.

As shown in FIG. 1 and FIG. 2, a hydraulic control valve 25 that controls a hydraulic pressure to drive the variable valve timing device 18 and the intermediate lock mechanism 50 is constructed of a hydraulic control valve (for example, an electromagnetically driven spool valve) that integrates a hydraulic control valve function for a phase control which controls a hydraulic pressure to drive the VCT phase and a hydraulic control valve function for a lock control which controls a hydraulic pressure to drive the lock pin 58. Oil (hydraulic oil) in an oil pan 27 is sucked up by an oil pump 28 driven by a power of the engine 11 and is supplied to the hydraulic control valve 25.

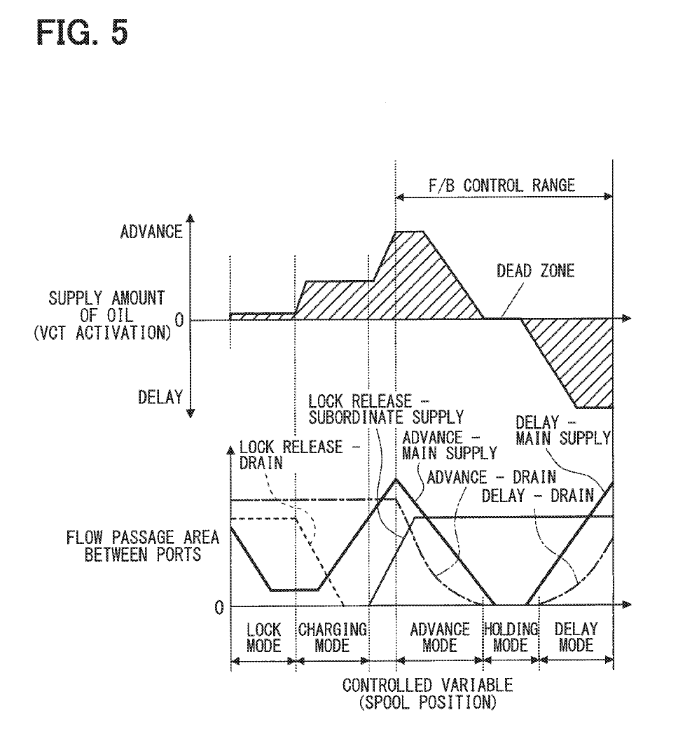

As shown in FIG. 5, a controlled variable (spool position) of the hydraulic control valve 25 is divided into five control ranges of a lock mode, a charging mode, an advance mode, a holding mode, and a delay mode. The engine control circuit 21 switches a control mode of the hydraulic control valve 25 among the lock mode, the charging mode, the advance mode, the holding mode, and the delay mode to thereby set the controlled variable of the hydraulic control valve 25 within a control range of the control mode.

In the control range of the lock mode, a lock releasing port communicating with the lock releasing hydraulic chamber 60 is connected to a drain port to thereby relieve the hydraulic pressure in the lock releasing hydraulic chamber 60, whereby the lock pin 58 is protruded in the lock direction by the spring 62. When the lock pin 58 is fitted in the lock hole 59 in this way, the VCT phase is locked in the intermediate lock phase. In this regard, an advance port communicating with the advance chamber 42 is connected to a main supply port and a delay port communicating with the delay chamber 43 is connected to the drain port.

In the control range of the charging mode, the advance port communicating with the advance chamber 42 is connected to the main supply port to thereby supply the oil to the advance chamber 42. In this regard, the lock releasing port communicating with the lock releasing hydraulic chamber 60 is connected to the drain port or interrupts connection to the drain port, and the delay port communicating with the delay chamber 43 is connected to the drain port.

In the control range other than the lock mode and the charging mode (that is, the control range of the advance mode, the holding mode, and the delay mode), the lock releasing port communicating with the lock releasing hydraulic chamber 60 is connected to a subordinate supply port to thereby charge the oil in the lock releasing hydraulic chamber 60, whereby the lock pin 58 is driven in a lock releasing direction by the hydraulic pressure of the lock releasing hydraulic chamber 60. In this way, the lock pin 58 is removed from the lock hole 59, whereby the VCT phase is released from lock.

In the control range of the advance mode, the delay port communicating with the delay chamber 43 is connected to the drain port to remove the hydraulic pressure in the delay chamber 43 and the advance port communicating with the advance chamber 42 is connected to the main supply port to thereby supply the oil to the advance chamber 42, whereby the VCT phase is advanced. At this time, an amount of oil supplied to the advance chamber 42 is varied according to the controlled variable (spool position) of the hydraulic control valve 25, whereby an advance speed of the VCT phase is varied.

In the control range of the holding mode, the connection of the advance port communicating with the advance chamber 42 and the delay port communicating with the delay chamber 42 with the drain port is interrupted to thereby hold the hydraulic pressure in the advance chamber 42 and the delay chamber 43, whereby the VCT phase is held unmoved.

In the control range of the delay mode, the advance port communicating with the advance chamber 42 is connected to the drain port, whereby the hydraulic pressure in the advance chamber 42 is removed, and the delay port communicating with the delay chamber 43 is connected to the main supply port to thereby supply the oil to the delay chamber 43, whereby the VCT phase is delayed. At this time, an amount of oil supplied to the advance chamber 42 is varied according to the controlled variable (spool position) of the hydraulic control valve 25, whereby a delay speed of the VCT phase is varied.

The engine control circuit 21 calculates the target VCT phase (target valve timing) according to the engine operating state and the like and performs a phase F/B control which F/B controls the controlled variable of the hydraulic control valve 25 in such a way as to make the real VCT phase (real valve timing) correspond with the target VCT phase to thereby F/B control the hydraulic pressure to be supplied to the advance chamber 42 and the delay chamber 43 of the variable valve timing device 18. Here, “F/B” means “feedback”. A control range of this phase F/B extends over the advance mode, the holding mode, and the delay mode.

Further, when an engine stop request is made, the engine control circuit 21 sets the target VCT phase to a vicinity of the intermediate lock phase (the intermediate lock phase or near the intermediate lock phase) to thereby control the real VCT phase to the vicinity of the intermediate lock phase (target VCT phase) by the phase F/B control. Then, the control mode of the hydraulic control valve 25 is switched to the lock mode (the controlled variable of the hydraulic control valve 25 is set to within the control range of the lock mode), whereby the lock pin 58 is protruded in the lock direction. In this way, the lock pin 58 is fitted in the lock hole 59 before the engine 11 is stopped, whereby the VCT phase is locked in the intermediate lock phase. At the time of the next engine startup, the engine 11 is started in a lock state in which the VCT phase is locked in the intermediate lock phase (a pin fitting state in which the lock pin 58 is fitted in the lock hole 59).

However, when there is brought about a state in which preference needs to be given to a part protection or a user's operation while the engine 11 is being operated and hence a quick engine stop request is made, there is also a case where the engine 11 is stopped in a non-lock state in which the VCT phase is not locked in the intermediate phase (pin not-yet fitting state in which the lock pin 58 is not fitted in the lock hole 59).

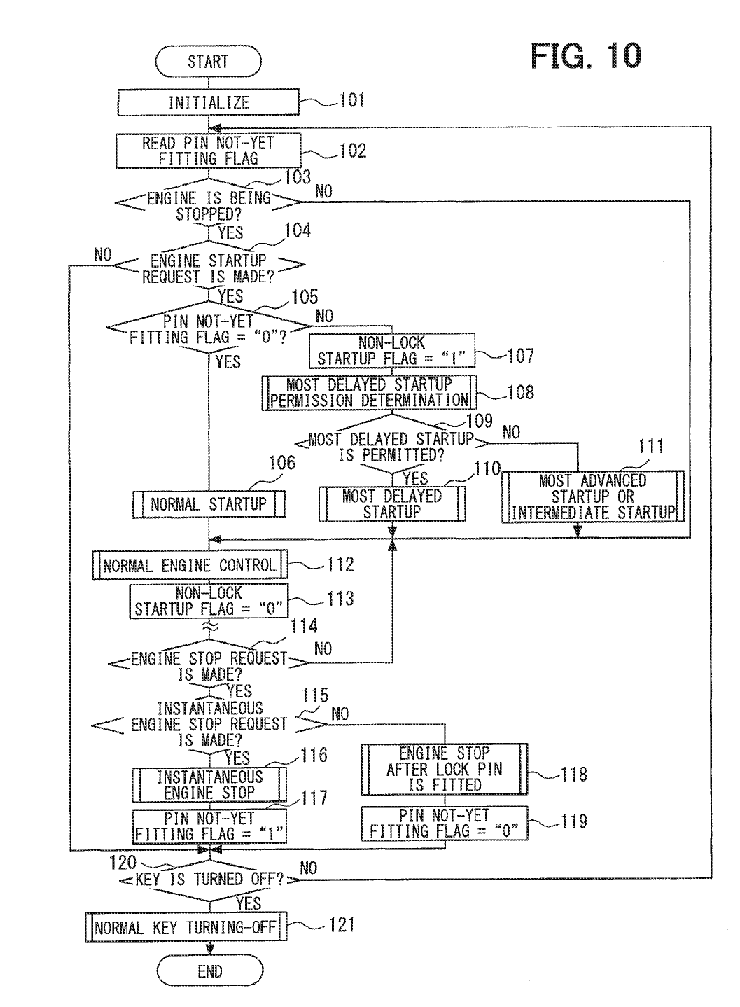

As a countermeasure in a case where the engine 11 is stopped in the non-lock state (pin not-fitting state), in the present first embodiment, respective routines shown in FIG. 10 to FIG. 15, which will be described later, are performed by the engine control circuit 21, whereby the following control is performed.

In a case where the engine 11 is stopped in the non-lock state (pin not-yet fitting state), at the time of the next startup, the engine control circuit 21 performs most delayed startup processing for controlling the VCT phase to a vicinity of the most delayed phase (the most delayed phase or within a specified range from the most delayed phase) and then starting up the engine 11. In this way, at the time of a startup in the non-lock state (at the time of the next startup in a case where the engine 11 is stopped in the non-lock state), the engine 11 is started up in a state in which the VCT phase is displaced to the most delayed phase or is moved close to the vicinity of the most delayed phase. In this way, at the time of the startup in the non-lock state, the engine 11 can be quickly started up without locking the VCT phase.

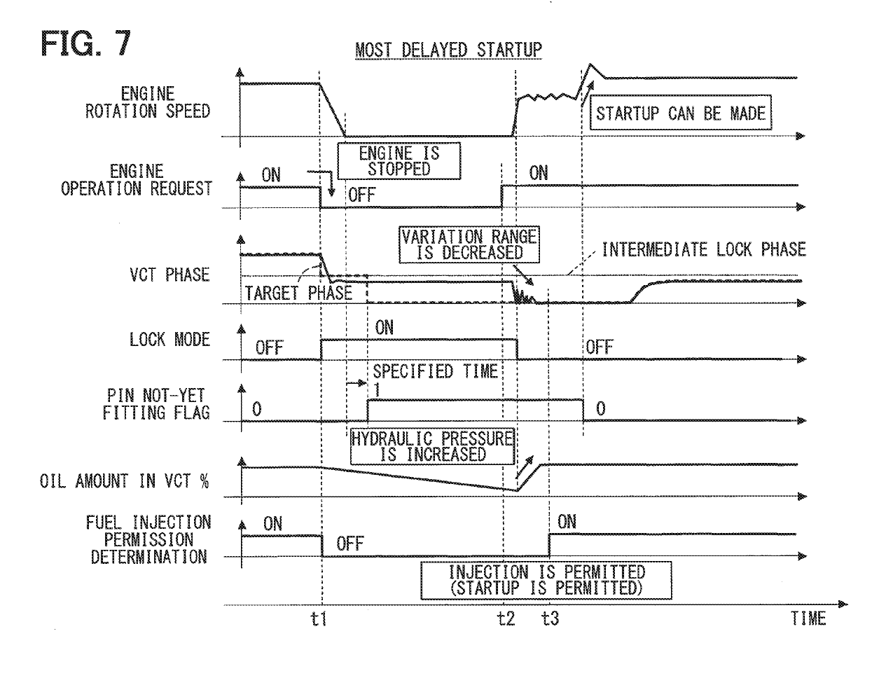

Specifically, as shown in FIG. 7 to FIG. 9, in a case where there is brought about a situation in which preference needs to be given to a part protection or a user's operation while the engine 11 is being operated and hence an instantaneous engine stop request is made, at this timing t1, the engine 11 is quickly stopped. In this case, the engine 11 is stopped in the non-lock state in which the VCT phase is not locked in the intermediate lock phase (the pin not-yet fitting state in which the lock pin 58 is not fitted in the lock hole 59), so that after the engine 11 is stopped, “1” is set to a pin not-yet fitting flag.

Then, in a case where the pin not-yet fitting flag is “1” at a timing t2 when the next engine startup request is made, it is determined that the engine 11 is in the non-lock state (pin not-yet fitting state). Then, on the basis of temperature information and a battery voltage, it is determined in the most delayed startup processing that the engine 11 can be started up.

As a result, in a case where it is determined in the most delayed startup processing that the engine 11 can be started up, as shown in FIG. 7, the engine control circuit 21 performs the most delayed startup processing. In this most delayed startup processing, the engine 11 is cranked in a high rotation range not less than the specified rotation speed (the high rotation range not less than a rotation speed in which the engine 11 can be started up in the most delayed startup processing in an ordinary temperature state) and the VCT phase is controlled to the vicinity of the most delayed phase (the most delayed phase or within the specified range from the most delayed phase). At this time, the hydraulic pressure is quickly increased by cranking the engine 11 at a high rotation speed and hence the VCT phase is quickly controlled to the vicinity of the most delayed phase and a range of vibration in the VCT phase is decreased as the oil is charged. Then, at a timing t3 when the VCT phase is moved to the vicinity of the most delayed phase, a fuel injection and an ignition of the engine 11 are started, whereby the engine 11 is started up.

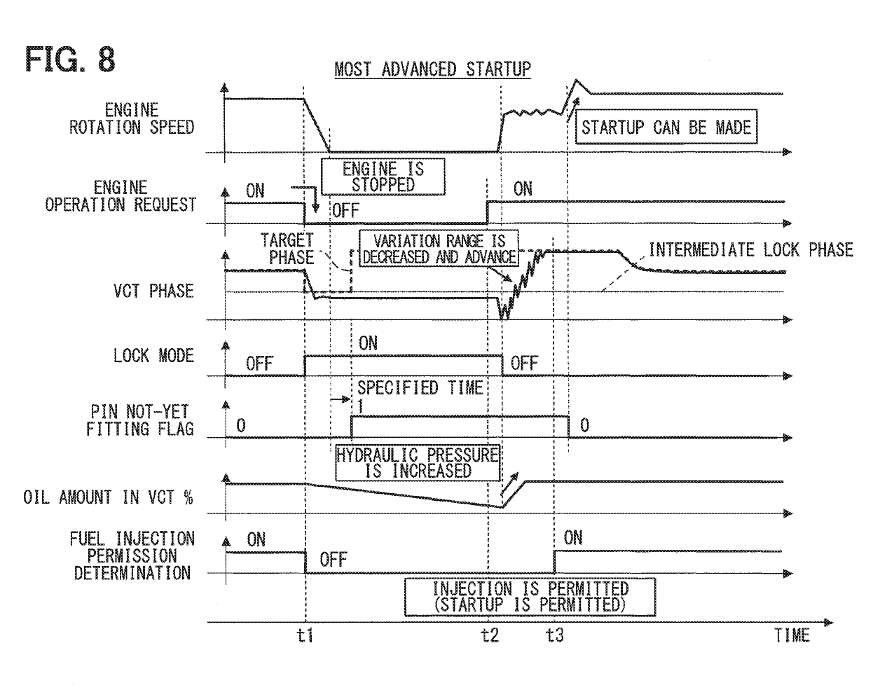

On the other hand, in a case where it is determined in the most delayed startup processing that there is not a state in which the engine 11 can be started up, as shown in FIG. 8, the engine control circuit 21 performs most advanced startup processing. In this most advanced startup processing, the engine 11 is cranked in a high rotation range not less than a specified rotation speed and the VCT phase is controlled to a vicinity of a most advanced phase (a most advanced phase or within a specified range from the most advanced phase). At this time, by cranking the engine 11 at a high rotation speed, the hydraulic pressure is quickly increased and hence the VCT phase is quickly controlled to the vicinity of the most advanced phase and a range of variation in the VCT phase is decreased as the oil is charged. Then, at a timing t3 when the VCT phase is moved to the vicinity of the most advanced phase, a fuel injection and an ignition of the engine 11 are started, whereby the engine 11 is started up.

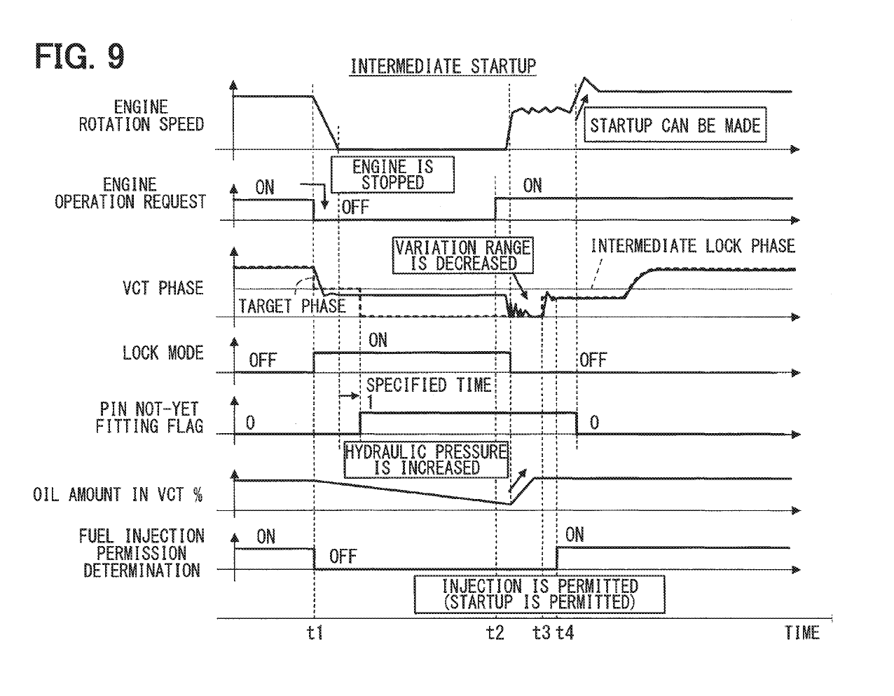

Alternatively, in the case where it is determined in the most delayed startup processing that there is not a state in which the engine 11 can be started up, as shown in FIG. 9, the engine control circuit 21 may perform intermediate startup processing. In this intermediate startup processing, first, the engine 11 is cranked in a high rotation range not less than a specified rotation speed and the VCT phase is controlled to the vicinity of the most delayed phase. At this time, by cranking the engine 11 at a high rotation speed, the hydraulic pressure is quickly increased and hence the VCT phase is quickly controlled to the vicinity of the most delayed phase and a range of variation in the VCT phase is decreased as the oil is charged. Then, at the timing t3 when the VCT phase is moved to the vicinity of the most delayed phase, the VCT phase is controlled to an intermediate phase located on an advance side by a specified amount from the vicinity of the most delayed phase. Then, at a timing t4 when the VCT phase reaches the intermediate phase, a fuel injection and an ignition of the engine 11 are started, whereby the engine 11 is started up.

Hereinafter, a processing content of each routine which is performed by the engine control circuit 21 in the present first embodiment and which is shown in FIG. 10 to FIG. 15 will be described.

### [Main Control Routine]

A main control routine shown in FIG. 10 is performed after an electric power of the engine control circuit 21 is turned on and acts as a control part. In step 101, initializing processing is performed and processing after step 102 is performed at a specified period (time synchronously).

In step 102, a pin not-yet fitting flag stored in a backup RAM when the engine 11 is stopped last time is read and then the routine proceeds to step 103, where it is determined whether or not the engine 11 is being stopped.

In a case where it is determined in this step 103 that the engine 11 is being stopped, the routine proceeds to step 104, where it is determined whether or not an engine startup request is made. In a case where it is determined that the engine startup request is not made, processing in steps 105 to 119 are skipped and the routine proceeds to step 120.

Then, when it is determined in step 104 that the engine startup request is made, the routine proceeds to step 105, where it is determined whether or not the VCT phase is in the lock state (pin fitting state) by whether or not the pin not-yet fitting flag is “0”.

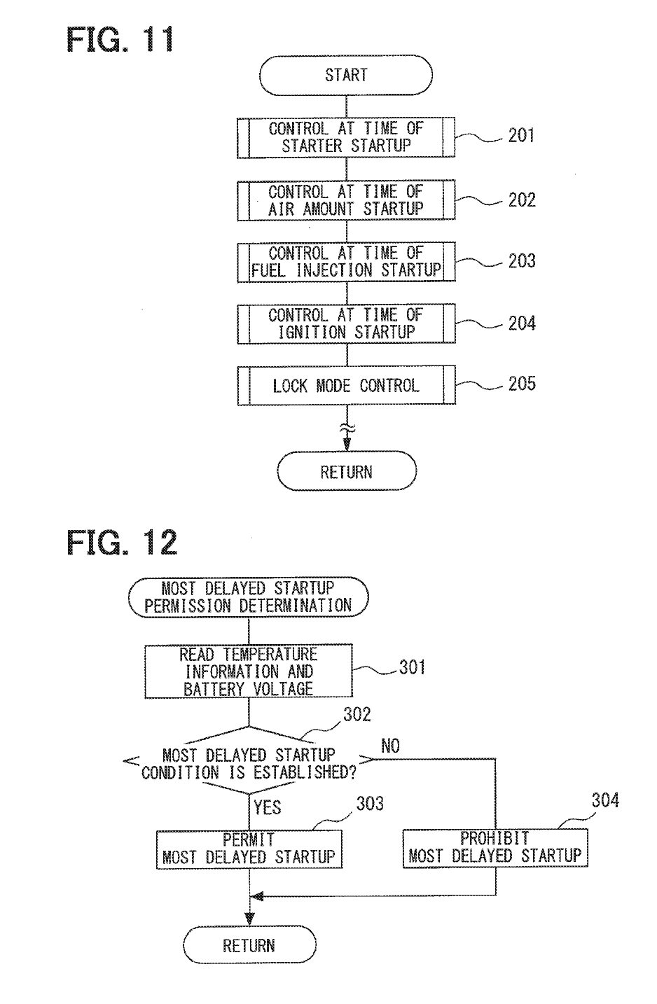

In a case where it is determined in this step 105 that the pin not-yet fitting flag is “0”, it is determined that the VCT phase is in the lock state (pin fitting state) and the routine proceeds to step 106, where a normal startup processing routine shown in FIG. 11, which will be described later, is performed, whereby normal startup processing is executed. In this normal startup processing, the engine 11 is cranked in the lock state in which the VCT phase is locked in the intermediate lock phase and the fuel injection and the ignition of the engine 11 are started, whereby the engine 11 is started.

On the other hand, in a case where it is determined in step 105 that the pin not-yet fitting flag is “1”, it is determined that the VCT phase is in the non-lock state (pin not-yet fitting state) and the routine proceeds to step 107, where “1” is set to a non-lock startup flag.

Then, the routine proceeds to step 108, where a most delayed startup permission determination routine shown in FIG. 12, which will be described later, is executed. Then, on the basis of the temperature information and the battery voltage, it is determined whether or not there is brought about a state in which the engine 11 can be started up by most delayed startup processing and according to a determination result, it is determined whether a most delayed startup is permitted or prohibited.

In step 109, it is determined whether or not the most delayed startup can be permitted on the basis of the determination result of the most delayed startup permission determination routine (step 108). In other words, it is determined whether or not there is brought about a state in which the engine 11 can be started up by the most delayed startup processing.

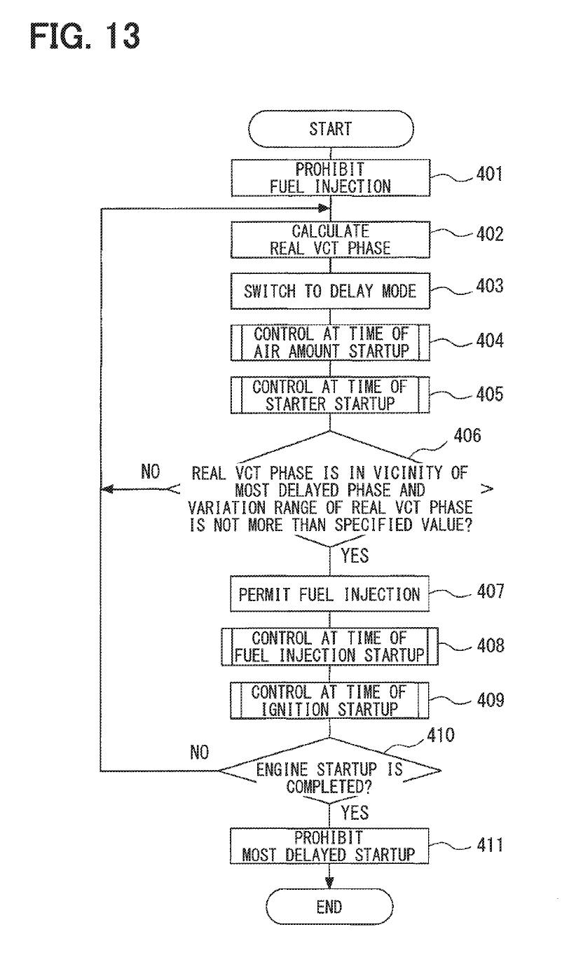

In a case where it is determined in this step 109 that the most delayed startup is permitted, the routine proceeds to step 110, where the most delayed startup processing routine shown in FIG. 13, which will be described later, is executed, whereby the most delayed startup processing is performed. In this most delayed startup processing, the engine 11 is cranked in the high rotation range not less than the specified rotation speed and the VCT phase is controlled to the vicinity of the most delayed phase (the most delayed phase or within the specified range from the most delayed phase). Then, when the VCT phase reaches the vicinity of the most delayed phase, the fuel injection and the ignition of the engine 11 are started, whereby the engine 11 is started.

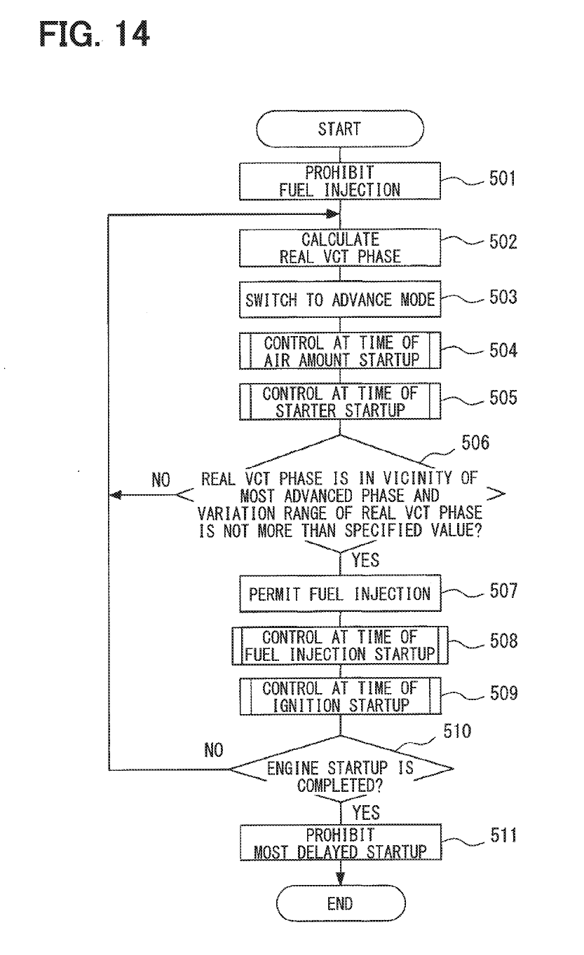

On the other hand, in a case where it is determined in this step 109 that the most delayed startup is prohibited (there is not brought about a state in which the engine 11 can be started up by the most delayed startup processing), the routine proceeds to step 111, where a most advanced startup processing routine shown in FIG. 14, which will be described later, is executed, whereby most advanced startup processing is performed. In this most advanced startup processing, the engine 11 is cranked in the high rotation range not less than the specified rotation speed and the VCT phase is controlled to a vicinity of the most advanced phase (the most advanced phase or within a specified range from the most advanced phase). Then, when the VCT phase reaches the vicinity of the most advanced phase, the fuel injection and the ignition of the engine 11 are started, whereby the engine 11 is started.

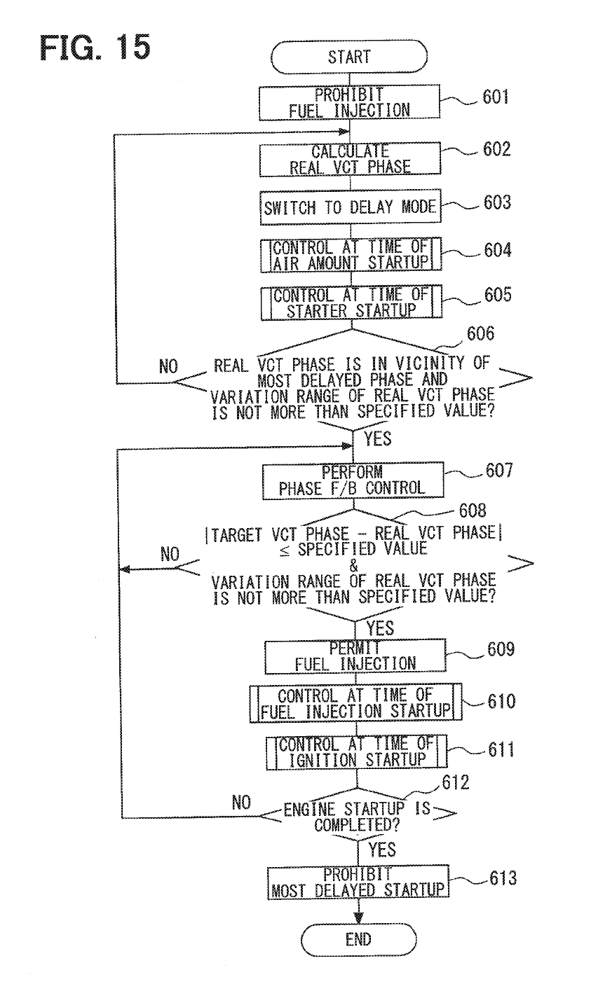

Alternatively, it is also recommended to execute an intermediate startup processing routine shown in FIG. 15, which will be described later, in step 111 to thereby perform the intermediate startup processing. In this intermediate startup processing, first, the engine 11 is cranked in the high rotation range not less than the specified rotation speed and the VCT phase is controlled to the vicinity of the most delayed phase. Then, when the VCT phase reaches the vicinity of the most delayed phase, the VCT phase is controlled to an intermediate phase located on an advance side by a specified amount from the vicinity of the most delayed phase. Then, when the VCT phase reaches the intermediate phase, the fuel injection and the ignition of the engine 11 are started, whereby the engine 11 is started.

After the engine 11 is started up, the routine proceeds to step 112, where a normal engine control is performed. Further, in a case where it is determined in step 103 that the engine 11 is not being stopped (in other words, the engine 11 is being operated), the processing in steps 104 to 111 are skipped and the routine proceeds to step 112, where the normal engine control is performed. Then, the routine proceeds to step 113, where the non-lock startup flag is reset to “0”.

While the engine 11 is being operated, the routine proceeds to step 114, where it is determined whether or not the engine stop request is made. In a case where it is determined that the engine stop request is not made, the routine returns to step 112.

Then, when it is determined in step 114 that the engine stop request is made, the routine proceeds to step 115, where it is determined whether or not an instantaneous engine stop request is made. This instantaneous engine stop request means an engine stop request in which there is brought about a situation in which, for example, preference needs to be given to a part protection or a user's operation and in which the engine 11 hence needs to be stopped instantaneously.

In a case where it is determined in step 115 that the instantaneous engine stop request is made, the routine proceeds to step 116, where instantaneous engine stop processing is performed to quickly stop the engine 11. In this case, the engine 11 is stopped in the non-lock state in which the VCT phase is not locked in the intermediate phase (in the pin not-yet fitting state), so that the routine proceeds to step 117, where “1” is set to the pin not-yet fitting flag and where the pin not-yet fitting flag is stored in the backup RAM.

On the other hand, in a case where it is determined in step 115 that the instantaneous engine stop request is not made, the routine proceeds to step 118, where the VCT phase is locked in the intermediate phase (the lock pin 58 is fitted in the lock hole 59) before stopping the engine 11 and then engine stop processing is performed to thereby stop the engine 11. Then, the routine proceeds to step 119, where the pin not-yet fitting flag is reset to “0” and where the pin not-yet fitting flag is stored in the backup RAM.

Then, the routine proceeds to step 120, where it is determined whether or not a key is turned off. In a case where it is determined that the key is not turned off, the routine returns to step 102. On the other hand, in a case where it is determined in step 120 that the key is turned off, the routine proceeds to step 121, where normal key turning-off processing (for example, learning processing or the like) is performed and the present routine is finished.

In this regard, in the routine shown in FIG. 10, “1” is set to the non-lock startup flag in step 107, but the present disclosure is not limited to this. For example, “1” may be set to the non-lock startup flag in step 117 and the non-lock startup flag may be stored in the backup RAM.

### [Normal Startup Processing Routine]

A normal startup processing routine shown in FIG. 11 is a sub-routine executed in step 106 of the main control routine shown in FIG. 10. In step 201, a control at the time of a starter startup is performed to thereby crank the engine 11 in the high rotation range not less than the specified rotation speed by the starter 30 (the motor for hybrid vehicle, the assisting motor, high output starter, the normal starter, or the like).

Then, the routine proceeds to step 202, where a control at the time of an air amount startup is performed to thereby control a throttle opening to a throttle opening at the time of the normal startup (for example, a throttle opening set according to a water temperature or the like at the time of the startup).

Then, the routine proceeds to step 203, where a control at the time of a fuel injection startup is performed to thereby control a fuel injection amount and a fuel injection timing to a fuel injection amount and a fuel injection timing at the time of the normal startup (for example, a fuel injection amount and a fuel injection timing set according to the water temperature or the like at the time of the startup).

Then, the routine proceeds to step 204, where a control at the time of an ignition startup is performed to thereby control an ignition timing to an ignition timing at the time of the normal startup (for example, an ignition timing set according to the water temperature or the like at the time of the startup).

Then, the routine proceeds to step 205, where the control mode of the hydraulic control valve 25 is held in the lock mode to thereby hold the hydraulic control valve 25 in the lock state (the pin fitting state). In this regard, the control mode of the hydraulic control valve 25 may be switched to the charging mode to thereby charge the oil with the hydraulic control valve 25 held in the lock state (the pin fitting state).

### [Most Delayed Startup Permission Determination Routine]

A most delayed startup permission determination routine shown in FIG. 12 is a subroutine executed in step 108 of the main control routine shown in FIG. 10 and acts as a determination part. In step 301, temperature information (for example, at least one of a water temperature, an oil temperature, an intake air temperature, and an outside air temperature) and a battery voltage are read.

In step 302, on the basis of the temperature information and the battery voltage, it is determined whether or not there is brought about a state in which the engine 11 can be started up by the most delayed startup processing (whether or not a most delayed startup condition is established).

At the time of an extremely low temperature (for example, not more than −30° C.), the engine 11 is hard to be started up by the most delayed startup processing. Hence, if the temperature information (for example, at least one of the water temperature, the oil temperature, the intake air temperature, and the outside air temperature) is monitored, it can be determined whether or not there is brought about a state in which the engine 11 can be started up by the most delayed startup processing. Further, when the battery voltage is extremely low, the engine 11 is likely to be not cranked in the high rotation range not less than the specified rotation speed. Hence, if the battery voltage is monitored, it can be determined whether or not there is brought about a state in which the engine 11 can be started up in the high rotation range not less than the specified rotation speed (in other words, a state in which the engine 11 can be started up by the most delayed startup processing).

Whether or not there is brought about a state in which the engine 11 can be started up by the most delayed startup processing is determined by whether or not the most delayed startup condition is established. As the most delayed startup condition, the following conditions (1) and (2) are employed.

(1) The temperature information or a temperature determination parameter generated from the temperature information is within a range in which a specified most delayed startup can be made (a range corresponding to a temperature higher than the extremely low temperature).

(2) The battery voltage is not less than an allowable lower limit value (a lower limit value of the battery voltage in which the engine 11 can be cranked in the high rotation range not less than the specified rotation speed).

In this regard, the condition of (2) described above may be changed to a condition of “an estimated cranking rotation speed calculated on the basis of the battery voltage is not less than the specified rotation speed”. In this case, for example, an estimated output of the starter 30 is calculated on the basis of the battery voltage and then the estimated cranking rotation speed is calculated on the basis of the estimated output.

If both of the conditions (1) and (2) are satisfied, the most delayed startup condition is established. However, if any one of the conditions (1) and (2) is not satisfied, the most delayed startup condition is not established.

In a case where it is determined in this step 302 that the most delayed startup condition is established, it is determined that the engine 11 can be started up by the most delayed startup processing and the routine proceeds to step 303, where it is determined that the most delayed startup is permitted.

On the other hand, in a case where it is determined in this step 302 that the most delayed startup condition is not established, it is determined that the engine 11 cannot be started up by the most delayed startup processing and the routine proceeds to step 304, where it is determined that the most delayed startup is prohibited.

### [Most Delayed Startup Processing Routine]

A most delayed startup processing routine shown in FIG. 13 is a subroutine performed in step 110 of the main control routine shown in FIG. 10. After prohibiting the fuel injection in step 401, the routine proceeds to step 402, where the real VCT phase is calculated on the basis of the crank angle signal and the cam angle signal.

Then, the routine proceeds to step 403, where the control mode of the hydraulic control valve 25 is switched to a delay mode (set the controlled variable of the hydraulic control valve 25 to within a control range of the delay mode) to thereby delay the VCT phase. At this time, the controlled variable (spool position) of the hydraulic control valve 25 is set in such a way that an amount of oil to be supplied to the delay chamber 43 becomes a maximum value.

Then, the routine proceeds to step 404, where the control at the time of the air amount startup is performed to thereby control the throttle opening to a throttle opening at the time of the normal startup. In this regard, the throttle opening may be made larger than the throttle opening at the time of the normal startup.

Then, the routine proceeds to step 405, where the control at the time of the starter startup is performed to thereby crank the engine 11 in the high rotation range not less than the specified rotation speed by the starter 30 (the motor for the hybrid vehicle, the assisting motor, the high output starter, or the normal starter). In this regard, in a case of a system in which a cranking rotation speed can be made higher (for example, in a case where the motor for the hybrid vehicle or the assisting motor is used as the starter 30), as required, the cranking rotation speed may be made higher than the cranking rotation speed at the time of the normal startup. Specifically, a target cranking rotation speed is changed according to the temperature information (for example, as the water temperature is lower, the target cranking rotation speed is made higher), the cranking rotation speed is increased to a rotation speed in which the engine 11 can be surely started up.

Then, the routine proceeds to step 406, where it is determined whether or not: the real VCT phase is in the vicinity of the most delayed phase (the most delayed phase or within the specified range from the most delayed phase); and the range of variation (for example, a difference between a peak value and a bottom value) in the real VCT phase becomes not more than a specified value.

In a case where this step 406 is determined to be “NO”, the routine returns to step 402.

Then, when it is determined in step 406 that the real VCT phase is in the vicinity of the most delayed phase and that the range of variation in the real VCT phase becomes not more than the specified value, the routine proceeds to step 407, where the fuel injection is permitted. Then, the routine proceeds to step 408, where the control at the time of the fuel injection startup is performed to thereby control a fuel injection amount and a fuel injection timing to a fuel injection amount and a fuel injection timing at the time of the normal startup. In this regard, the fuel injection timing may be advanced as compared with the fuel injection timing at the time of the normal startup.

Then, the routine proceeds to step 409, where the control at the time of the ignition startup is performed to thereby control the ignition timing to the ignition timing at the time of the normal startup. In this regard, the ignition timing may be advanced as compared with the ignition timing at the time of the normal startup.

Then, the routine proceeds to step 410, where it is determined whether or not a startup of the engine 11 is completed, for example, by whether or not an engine rotation speed becomes more than a complete combustion determination value. In a case where it is determined that the startup of the engine 11 is not completed, the routine returns to step 402.

Then, when it is determined in step 410 that the startup of the engine 11 is completed, the routine proceeds to step 411, where the determination that the most delayed startup is permitted is returned to the determination that the most delayed startup is prohibited and then the present routine is finished.

### [Most Advanced Startup Processing Routine]

A most advanced startup processing routine shown in FIG. 14 is a subroutine executed in step 111 of the main control routine shown in FIG. 10. After prohibiting the fuel injection in step 501, the routine proceeds to step 502, where the real VCT phase is calculated on the basis of the crank angle signal and the cam angle signal.

Then, the routine proceeds to step 503, where the control mode of the hydraulic control valve 25 is switched to an advance mode (set the controlled variable of the hydraulic control valve 25 to within a control range of the advance mode) to thereby advance the VCT phase. At this time, the controlled variable (spool position) of the hydraulic control valve 25 is set in such a way that an amount of oil to be supplied to the advance chamber 42 becomes a maximum value.

Then, the routine proceeds to step 504, where the control at the time of the air amount startup is performed to thereby control the throttle opening to the throttle opening at the time of the normal startup. In this regard, the throttle opening may be made larger than the throttle opening at the time of the normal startup.

Then, the routine proceeds to step 505, where the control at the time of the starter startup is performed to crank the engine 11 in the high rotation range not less than the specified rotation speed by the starter 30. In this regard, in a case of a system in which the cranking rotation speed can be made higher, as required, the cranking rotation speed may be made higher than the cranking rotation speed at the time of the normal startup.

Then, the routine proceeds to step 506, where it is determined whether or not: the real VCT phase is in the vicinity of the most advanced phase (the most advanced phase or within a specified range from the most advanced phase); and the range of variation in the real VCT phase becomes not more than the specified value.

In a case where this step 506 is determined to be “NO”, the routine returns to step 502.

Then, when it is determined in step 506 that the real VCT phase is in the vicinity of the most delayed phase and that the range of variation in the real VCT phase becomes not more than the specified value, the routine proceeds to step 507, where the fuel injection is permitted. Then, the routine proceeds to step 508, where the control at the time of the fuel injection startup is performed to thereby control a fuel injection amount and a fuel injection timing to a fuel injection amount and a fuel injection timing at the time of the normal startup. In this regard, the fuel injection timing may be advanced as compared with the fuel injection timing at the time of the normal startup.

Then, the routine proceeds to step 509, where the control at the time of the ignition startup is performed to thereby control the ignition timing to the ignition timing at the time of the normal startup. In this regard, the ignition timing may be advanced as compared with the ignition timing to the ignition timing at the time of the normal startup.

Then, the routine proceeds to step 510, where it is determined whether or not a startup of the engine 11 is completed. In a case where it is determined that the startup of the engine 11 is not completed, the routine returns to step 502.

Then, when it is determined in step 510 that the startup of the engine 11 is completed, the routine proceeds to step 511, where the most delayed startup is held prohibited and then the present routine is finished.

### [Intermediate Startup Processing Routine]

An intermediate startup processing routine shown in FIG. 15 is a subroutine executed in step 111 of the main control routine shown in FIG. 10. When the present routine is started, first, in step 601, the fuel injection is prohibited and then the routine proceeds to step 602, where the real VCT phase is calculated on the basis of the crank angle signal and the cam angle signal.

Then, the routine proceeds to step 603, where the control mode of the hydraulic control valve 25 is switched to a delay mode (set the controlled variable of the hydraulic control valve 25 to within a control range of the delay mode) to thereby delay the VCT phase. At this time, the controlled variable (spool position) of the hydraulic control valve 25 is set in such a way that an amount of oil to be supplied to the delay chamber 43 becomes a maximum value.

Then, the routine proceeds to step 604, where the control at the time of the air amount startup is performed to thereby control the throttle opening to the throttle opening at the time of the normal startup. In this regard, the throttle opening may be made larger than the throttle opening at the time of the normal startup.

Then, the routine proceeds to step 605, where the control at the time of the starter startup is performed to thereby crank the engine 11 in the high rotation range not less than the specified rotation speed by the starter 30. In this regard, in a case of a system in which the cranking rotation speed can be made higher, as required, the cranking rotation speed may be made higher than the cranking rotation speed at the time of the normal startup.

Then, the routine proceeds to step 606, where it is determined whether or not: the real VCT phase is in the vicinity of the most delayed phase (the most delayed phase or within the specified range from the most delayed phase; and the range of variation in the real VCT phase becomes not more than the specified value.

In a case where this step 606 is determined to be “NO”, the routine returns to step 602.

Then, when it is determined in step 606 that the real VCT phase is in the vicinity of the most delayed phase and that the range of variation in the real VCT phase becomes not more than the specified value, the routine proceeds to step 607, where the target VCT phase is set to an intermediate phase located on an advance side by a specified amount as compared with the most delayed phase and where the real VCT phase is controlled to the target VCT phase (the intermediate phase) by a phase F/B control.

Then, the routine proceeds to step 608, where it is determined whether or not: an absolute value of a difference between the target VCT phase (the intermediate phase) and the real VCT phase is not more than a specified value; and the range of variation in the real VCT phase is not more than a specified value.

Then, in a case where this step 608 is determined to be “NO”, the routine returns to step 607.

Then, when it is determined in step 608 that the absolute value of the difference between the target VCT phase (the intermediate phase) and the real VCT phase is not more than the specified value and that the range of variation in the real VCT phase is not more than the specified value, the routine proceeds to step 609, where the fuel injection is permitted. Then, the proceeds to step 610, where the control at the time of the fuel injection startup is performed to thereby control a fuel injection amount and a fuel injection timing to a fuel injection amount and a fuel injection timing at the time of the normal startup. In this regard, the fuel injection timing may be advanced as compared with the fuel injection timing at the time of the normal startup.

Then, the routine proceeds to step 611, where the control at the time of the ignition startup is performed to thereby control the ignition timing to the ignition timing at the time of the normal startup. In this regard, the ignition timing may be advanced as compared with the ignition timing at the time of the normal startup.

Then, the routine proceeds to step 612, where it is determined whether or not the startup of the engine 11 is completed. In a case where it is determined that the startup of the engine 11 is not completed, the routine returns to step 607.

Then, when it is determined in step 612 that the startup of the engine 11 is completed, the routine proceeds to step 613, where the most delayed startup is held prohibited and then the present routine is finished.

In the first embodiment described above, in a case where the engine 11 is stopped in the non-lock state in which the VCT phase is not locked in the intermediate phase, at the time of the next startup, the engine control circuit 21 performs the most delayed startup processing for controlling the VCT phase to the vicinity of the most delayed phase and starting up the engine 11. In this way, at the time of the startup in the non-lock state, the engine 11 can be started up in a state in which the VCT phase is displaced to the most delayed phase or is moved to the vicinity of the most delayed phase, whereby the engine 11 can be quickly started up without locking the VCT phase. In this case, the VCT phase does not need to be locked at the time of the startup 11 in the non-lock state and hence the following advantages (1) to (5) can be obtained.

(1) At the time of the startup in the non-lock state (the pin not-yet fitting state), irrespective of an oil state in the advance chamber 42 and the delay chamber 43 of the variable valve timing device 18 (even in a case where the advance chamber 42 and the delay chamber 43 are filled with the oil of high viscosity), by selecting the delay mode, the delay chamber 43 is charged with the oil while discharging the oil in the advance chamber 42, whereby the VCT phase can be quickly shifted to a stable state and the engine 11 can be reliably started up.

(2) Irrespective of a state in which the lock pin 58 is fixed and the oil state in the advance chamber 42 and the delay chamber 43 (even in a case where the advance chamber 42 and the delay chamber 43 are filled with the oil of high viscosity), the startup of the engine 11 in the non-lock state (the pin not-yet fitting state) can be succeeded.

(3) Even if the lock pin 58 is fixed in a protruding state, by selecting the delay mode, the lock pin 58 can be pulled in to thereby avoid the lock pin 58 from being continuously fixed, in other words, the lock pin 58 can be quickly eliminated from being fixed.

(4) A variable valve timing device of an expensive and complex structure which is provided in a ratchet mechanism is not required (the ratchet mechanism can be omitted), so that not only cost can be reduced but also a safety factor and reliability can be improved.

(5) As compared with a conventional method for determining whether or not the advance chamber 42 and the delay chamber 43 are filled with oil at the time of a startup in a non-lock state (pin not-yet fitting state) and selecting a mode other than a lock mode and then starting up an engine, a cranking time can be shortened. In the conventional method, a process of “lock mode→because lock cannot be made (pin cannot be fitted), it is determined that the advance chamber 42 and the delay chamber 43 are filled with the oil or that the pin is fixed→the engine is started up by other action”, is performed. Hence, a considerable time is required.

Further, in the present first embodiment, the engine 11 can be cranked in the high rotation range not less than the specified rotation speed (for example, a high rotation range not less than a rotation speed in which the engine 11 can be started up by the most delayed startup processing in a normal temperature state). In this way, when the most delayed startup processing is performed, even in a case where the VCT phase is in the vicinity of the most delayed phase, the engine 11 can be cranked and started up in the high rotation range not less than the specified rotation speed.

Still further, in the present first embodiment, at the time of the startup in the non-lock state, on the basis of the temperature information (at least any one of the water temperature, the oil temperature, the intake air temperature, and the outside air temperature) and the battery voltage, it is determined whether or not the engine 11 can be started up by the most delayed startup processing, and in a case where it is determined that the engine 11 can be started up by the most delayed startup processing, the most delayed startup processing is performed. In this way, only in a case where the engine 11 can be started up by the most delayed startup processing, the most delayed startup processing can be performed. Hence, it is possible to prevent the most delayed startup processing from being performed although the engine 11 cannot be started up by the most delayed startup processing.

On the other hand, in a case where it is determined that the engine 11 cannot be started up by the most delayed startup processing, the engine control circuit 21 performs the most advanced startup processing for controlling the VCT phase to the vicinity of the most advanced phase and starting up the engine 11. Alternatively, the engine control circuit 21 performs the intermediate startup processing for controlling the VCT phase to the vicinity of the most delayed phase and then controlling the VCT phase to the intermediate phase located on an advance side by a specified amount from the vicinity of the most delayed phase and starting up the engine 11. In this way, even in a case where the engine 11 cannot be started up by the most delayed startup processing at the time of the startup in the non-lock state, the engine 11 can be started up by the most advanced startup processing or the intermediate startup processing without locking the VCT phase.

Further, in the present first embodiment, at the time of performing the most delayed startup processing, the cranking rotation speed is increased to a rotation speed in which the engine 11 can be surely started up, so that the engine 11 can be surely started up by the most delayed startup processing.

### Second Embodiment

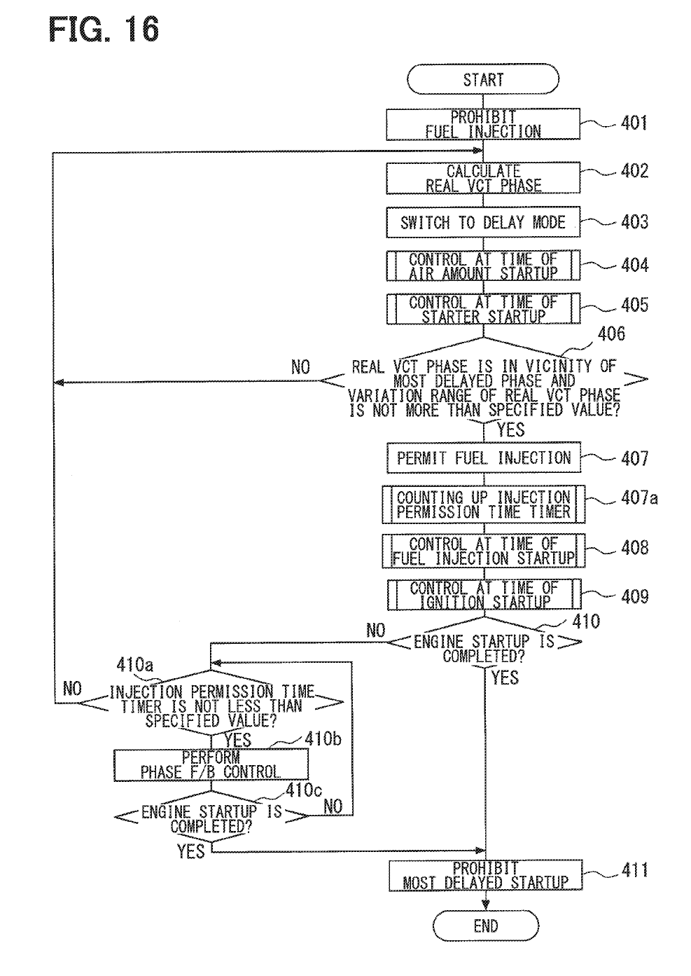

Next, a second embodiment of the present disclosure will be described with reference to FIG. 16. However, descriptions of parts substantially equal to those in the first embodiment will be omitted or simply made and parts different from those in the first embodiment will be mainly described.

In the second embodiment, in a case where even if the engine control circuit 21 executes the most delayed startup processing routine shown in FIG. 16, which will be described later, to thereby perform the most delayed startup processing, a state in which the engine 11 cannot be started up continues for a specified period or more, the engine control circuit 21 performs the intermediate startup processing for controlling the VCT phase to the intermediate phase located on the advance side by the specified amount from the vicinity of the most delayed phase and starting up the engine 11.

The routine executed in the present second embodiment and shown in FIG. 16 is a routine in which processing of step 407a is added after the processing of step 407 of the routine shown in FIG. 13 and in which processing of step 410a to 410c are added after the processing of step 410, and processing of other respective steps are the same as the processing of other respective steps shown in FIG. 13.

In the most delayed startup processing routine shown in FIG. 16, a fuel injection is prohibited in step 401 and then the routine proceeds to step 402, where the real VCT phase is calculated on the basis of the crank angle signal and the cam angle signal. Then, the routine proceeds to step 403, where the control mode of the hydraulic control valve 25 is switched to the delay mode, whereby the VCT phase is delayed.

Then, the routine proceeds to step 404, where the control at the time of the air amount startup is performed to thereby control the throttle opening to the throttle opening at the time of the normal startup. In this regard, the throttle opening may be made larger than the throttle opening at the time of the normal startup.

Then, the routine proceeds to step 405, where the control at the time of the starter startup is performed to thereby crank the engine 11 in the high rotation range not less than the specified rotation speed. In this regard, in a case of a system in which the cranking rotation speed can be further made higher, as required, the cranking rotation speed may be made higher than the cranking rotation speed at the time of the normal startup.

Then, the routine proceeds to step 406, where it is determined whether or not: the real VCT phase is in the vicinity of the most delayed phase; and the range of variation in the real VCT phase becomes not more than the specified value. In a case where this step 406 is determined to be “NO”, the routine returns to step 402.

Then, when it is determined in step 406 that the real VCT phase is in the vicinity of the most delayed phase and that the range of variation in the real VCT phase becomes not more than the specified value, the routine proceeds to step 407, where the fuel injection is permitted. Then, the routine proceeds to step 407a, where an injection permission time timer for counting a time which elapses from the time when the fuel injection is permitted is counted up.

Then, the routine proceeds to step 408, where the control at the time of the fuel injection startup is performed to thereby control the fuel injection amount and the fuel injection timing to the fuel injection amount and the fuel injection timing at the time of the normal startup. In this regard, the fuel injection timing may be advanced as compared with the fuel injection timing at the time of the normal startup.

Then, the routine proceeds to step 409, where the control at the time of the ignition startup is performed to thereby control the ignition timing to the ignition timing at the time of the normal startup. In this regard, the ignition timing may be advanced as compared with the ignition timing at the time of the normal startup.

Then, the routine proceeds to step 410, where it is determined whether or not the startup of the engine 11 is completed.

In a case where it is determined in this step 410 that the startup of the engine 11 is not completed, the routine proceeds to step 410a, where whether or not a state in which even if the most delayed startup processing is performed, the engine 11 cannot be started up continues for a specified time or more is determined by whether or not a count value of the injection permission time timer is not less than a specified value.

In a case where it is determined in step 410a that the count value of the injection permission time timer does not reach the specified value, the routine returns to step 402.

Then, in a case where it is determined in step 410 that the startup of the engine 11 is completed, the routine proceeds to step 411, where the determination that the most delayed startup is permitted is returned to the determination that the most delayed startup is prohibited and then the present routine is finished.

On the other hand, in a case where it is determined that the count value of the injection permission time timer becomes not less than the specified value, it is determined that a state in which even if the most delayed startup processing is performed, the engine 11 cannot be started up continues for the specified time or more and then the routine proceeds to step 410b. In step 410b, the target VCT phase is set to an intermediate phase located on an advance side by a specified value from the most delayed phase and the real VCT phase is controlled to the target VCT phase (intermediate phase) by the phase F/B control.

Then, the routine proceeds to step 410c, where it is determined whether or not the startup of the engine 11 is completed. In a case where it is determined that the startup of the engine 11 is not completed, the routine returns to step 410a.

Then, when it is determined in step 410c that the startup of the engine 11 is completed, the routine proceeds to step 411, where the determination that the most delayed startup is permitted is returned to the determination that the most delayed startup is prohibited and then the present routine is finished.

In the present second embodiment described above, in a case where even if the most delayed startup processing is performed, a state in which the engine 11 cannot be started up continues for the specified time or more, the engine control circuit 21 performs the intermediate startup processing for controlling the VCT phase to the intermediate phase located on the advance side by the specified amount from the vicinity of the most delayed phase and starting up the engine 11. In a case where even in this way, the engine 11 cannot be started up by the most delayed startup processing at the time of startup in the non-lock state, the engine 11 can be started up by the intermediate processing without locking the VCT phase.

Here, in the respective embodiments, at the time of the startup in the non-lock state, it is determined whether or not the engine 11 can be started up by the most delayed startup processing. However, the present disclosure is not limited to this but in a case of a system in which the cranking rotation speed can be further made higher (for example, in a case where the motor for the hybrid vehicle or the assisting motor is used as the starter 30), processing of steps 108, 109, 111 of the routine shown in FIG. 10 may be omitted and the most delayed startup processing may be always performed at the time of the startup in the non-lock state. In this case, it is recommended to change the target cranking rotation speed according to the temperature information at the time of performing the most delayed startup processing (for example, as the water temperature is lower, the target cranking rotation speed is made higher) to thereby increase the cranking rotation speed to a rotation speed in which the engine 11 can be reliably started up even at the extremely low temperature. Further, in a case where a state in which even if the most delayed startup processing is performed, the engine 11 cannot be started up continues for the specified time or more, the intermediate startup processing may be performed.

Further, in the respective embodiments described above, the present disclosure is applied to the variable valve timing device of the intake valve. However, the present disclosure is not limited to this but may be applied to the variable valve timing device of the exhaust valve.

In addition, the present disclosure can be variously modified within a scope not departing from the gist of the present disclosure: the construction of the variable valve timing device, the construction of the intermediate lock mechanism, and the construction of the hydraulic control valve may be modified as appropriate.

While the present disclosure has been described in accordance with embodiment thereof, it is to be understood that the present disclosure is not limited to the embodiments and constructions. The present disclosure covers various modifications and equivalent arrangements. In addition, the various combinations and configurations, other combinations and configurations including only a single element or more or less element are also within the spirit and scope of the present disclosure.

1. A control device for internal combustion engine that includes: a variable valve timing device of a hydraulic drive type which varies a rotation phase of a camshaft to a crankshaft of an internal combustion engine in a VCT phase to thereby vary a valve timing; an intermediate lock mechanism which locks the VCT phase in an intermediate lock phase located within an adjustable range of the VCT phase; and a control part which locks the VCT phase in the intermediate lock phase before the internal combustion engine is stopped and which starts up the internal combustion engine at a time of a next startup in a state in which the VCT phase is locked in the intermediate lock phase,
wherein in a case where the internal combustion engine is stopped in a non-lock state in which the VCT phase is not locked in the intermediate lock phase, at the time of the next startup, the control part performs most delayed startup processing for controlling the VCT phase to a most delayed phase or to within a specified range from the most delayed phase as a vicinity of the most delayed phase and starting up the internal combustion engine.

2. The control device for internal combustion engine according to claim 1,
wherein the internal combustion engine can be cranked in a high rotation range not less than a specified rotation speed.

3. The control device for internal combustion engine according to claim 2, comprising:
the internal combustion engine and a motor as a power source of a vehicle,
wherein the internal combustion engine can be cranked in the high rotation range by cranking the internal combustion engine by the motor.

4. The control device for internal combustion engine according to claim 2, comprising:
a motor that assists the internal combustion engine,
wherein the internal combustion engine can be cranked in the high rotation range by cranking the internal combustion engine by the motor.

5. The control device for internal combustion engine according to claim 2, comprising:
a high output starter that can crank the internal combustion engine in the high rotation range.

6. The control device for internal combustion engine according to claim 2,
wherein the internal combustion engine can be cranked in the high rotation range by reducing friction of the internal combustion engine.

7. The control device for internal combustion engine according to claim 1,
wherein the control part includes a determination part that determines whether or not the internal combustion engine can be started up by the most delayed startup processing at the time of a next startup in a case where the internal combustion engine is stopped in the non-lock state, and
in a case where the determination part determines that the internal combustion engine can be started up by the most delayed startup processing, the control part performs the most delayed startup processing.

8. The control device for internal combustion engine according to claim 7,
wherein the determination part determines whether or not the internal combustion engine can be started up by the most delayed startup processing on the basis of at least one of a water temperature, an oil temperature, an intake air temperature, an outside air temperature, and a battery voltage.

9. The control device for internal combustion engine according to claim 7,
wherein in a case where the determination part determines that the internal combustion engine cannot be started up by the most delayed startup processing, the control part performs most advanced startup processing for controlling the VCT phase to the most advanced phase or to within a specified range from the most advanced phase and starting up the internal combustion engine.

10. The control device for internal combustion engine according to claim 7,
wherein in a case where the determination part determines that the internal combustion engine cannot be started up by the most delayed startup processing, the control part performs intermediate startup processing for controlling the VCT phase to the vicinity of the most delayed phase and then controlling the VCT phase to an intermediate phase located on an advance side by a specified amount from the vicinity of the most delayed phase and starting up the internal combustion engine.

11. The control device for internal combustion engine according to claim 1,
wherein in a case where a state in which even if the most delayed startup processing is performed, the internal combustion engine cannot be started up continues for a specified time or more, the control part performs intermediate startup processing for controlling the VCT phase to an intermediate phase located on an advance side by a specified amount from the vicinity of the most delayed phase and starting up the internal combustion engine.

12. The control device for internal combustion engine according to claim 1,
wherein when the control part performs the most delayed startup processing, the control party increases a cranking rotation speed of the internal combustion engine to a rotation speed which can reliably start up the internal combustion engine.
